(19) United States
(12) Patent Application Publication
(10) Pub. No.: US 2003/0105882 A1
(43) Pub. Date: Jun. 5, 2003

(54) Transparent injection of intelligent proxies into existing distributed applications

(76) Inventors: Syed M. Ali, Sunnyvale, CA (US); Peter A. Yared, San Francisco, CA (US); Bruce K. Daniels, Capitola, CA (US); Robert N. Goldberg, Emerald Hills, CA (US); Yury Kamen, Foster City, CA (US)

Correspondence Address: Jonathan P. Osha, ROSENTHAL & OSHA L.L.P., 1221 McKinney Street, Suite 2800, Houston, TX, 77010, US

(21) Appl. No.: 09/997,927

(22) Filed: Nov. 30, 2001

(51) Int. Cl. G06F 15/16; G06F 9/54

(52) U.S. Cl. 709/310; 709/203

(57) ABSTRACT

A method for transparently injecting a proxy into a distributed application having a server portion and a client portion including creating the proxy that implements an interface of a remote object in the server portion and has a capability to cache data from the remote object, modifying the client portion to substitute a call for the remote object with a call for the proxy, and interposing a client runtime that includes the proxy between the client portion and the server portion.

### BACKGROUND OF INVENTION

1. Field of the Invention

The invention relates generally to communication between processes and, more specifically, to a method for optimizing the performance of a distributed application.

2. Background Art

Modern enterprise applications are typically implemented as multi-tier systems. Multi-tier systems serve the end-user through a chain of client/server pairs. Separation of objects across the client/server pairs is also an inherent aspect of enterprise applications. At runtime, the objects collaborate to provide functions to the system.

FIG. 1 shows an example of a four-tiered system comprising a user interface tier 2, a web server tier 4, an application server tier 6, and a data tier 8. The user interface tier 2 is the layer of interaction and typically includes a form-like graphical user interface (GUI) displayed by a display component, such as web browser 10. The data tier 8 includes a persistent data store, typically a database management system (DBMS) 12 and a database 14, where the database 14 contains a portion or all of the enterprise data. There are other persistent data store mechanisms, such as email stores, XML (“eXtensible Markup Language”) documents, spreadsheets, and so forth.

The web server tier 4 includes one or more programs 16 (only one program is shown) running in a web server 18 or in a container (not shown) that is either built into or connected to the web server 18. The program 16 contains the presentation logic that defines what the web browser 10 displays and how requests from the web browser 10 are handled. In a Java™-centric web application, for example, the program 16 could be a Java™ component such as JavaServer Pages™ (JSP™) page or Java™ servlet. The program 16 may contain one or more objects 20 that encapsulate the presentation logic.

The application server tier 6 includes one or more programs 22 (only one program is shown) running in an application server 24. The program 22 may contain one or more objects 26 that model the business rules and application data. In a Java™-centric web application, for example, the program 22 would include application components such as Enterprise JavaBeans™ (EJB™) components (also called beans). EJB™ provides two types of beans, called entity beans and session beans. Entity beans are persistent objects that model data within a persistent data store, such as database 14. Session beans are transient objects that perform operations, such as database read/write or calculations, on behalf of a client.

In the illustrated system, the web browser 10 and the web server 18 form a first client/server pair. The web server 18 and the application server 24 form a second client/server pair. The application server 24 and DBMS 12 form a third client/server pair. The web browser 10 and web server 18 communicate over a network link 28. The web server 18 and the application server 24 are separate processes, which may run on the same or separate physical machines. In the latter case, a network link 30 allows communication between the (client) program 16 and the (server) program 22. The application server 24 and DBMS 12 are separate processes, which may run on the same or separate physical machines. In the latter case, a network link 32 allows communication between the application server 24 and DBMS 12.

When the client program 16 and server program 22 run in different virtual machines, the client program 16 invokes methods of the (remote) objects 26 in the server program 22 using some form of remote procedure call (RPC), such as Remote Method Invocation (RMI). The client program 16 locates the remote objects 26 through an object lookup service 34 before invoking methods of the remote objects 26.

The granularity of an object is a measure of the size of the object and the number of the interactions the object makes with other objects. Large-grained objects have few interactions with other objects, while fine-grained objects have many interactions with other objects. Object-oriented, client/server programmers often develop server programs that embed large-grained and fine-grained object models. One of the consequences of fine-grained behavior is that the client program makes excessive remote method calls to the fine-grained object in the server program in order to access and update the attributes of the object. Remote method calls are expensive. For each remote method call, data may have to be marshaled and later un-marshaled, authentication may have to be performed before the client can use services provided by the server, packets may need to be routed through switches, and so forth. Thus, numerous remote method calls can have a huge impact on the performance and scalability of the application. For optimal distribution performance, the number of client/server roundtrips must be minimized.

Many client/server programmers use some form of caching to minimize client/server roundtrips. There are numerous “smart proxy” implementations that locally cache state from remote objects. See, for example, Wilson, Jeff M., “Get smart with proxies and RMI: Use dynamic loading to implement smart proxies in RMI,” Java World, November 2000, and Orbix Programmer's Guide Java Edition, available from IONA Technologies. Generally speaking, a “smart proxy” is a class that holds onto a remote object reference. The class is instantiated in the client's virtual machine. The smart proxy implements the interface of the remote object. The smart proxy may process the calls that it receives or forward the calls to the remote object. The client communicates with the smart proxy as it would with the remote object. Whether the remote object is located within the client's address space or on a remote machine is transparent to the client.

Smart proxies are typically added to the client or server program at the design/development stage of the application. There are no known implementations that transparently convert an existing (compiled or ready-to-run) distributed application to use smart proxies.

### SUMMARY OF INVENTION

In general, in one aspect, the invention relates to a method for transparently injecting a proxy into a distributed application having a server portion and a client portion. The method comprises creating the proxy that implements an interface of a remote object in the server portion and has a capability to cache data from the remote object. The method further includes modifying the client portion to substitute a call for the remote object with a call for the proxy and interposing a client runtime that includes the proxy between the client portion and the server portion.

In general, in one aspect, the invention relates to a method for transparently injecting a proxy into a distributed application having a server portion and a client portion. The method comprises creating the proxy for a plurality of remote objects in the server portion, each proxy implementing an interface of a corresponding remote object and having a capability to cache data from the corresponding remote object, modifying the client portion to substitute a call for a remote object with a call for a corresponding proxy, and interposing a runtime that includes the proxy between the client portion and the server portion.

In general, in one aspect, the invention relates to a method for transparently injecting a proxy into a distributed application having a server portion and a client portion which comprises analyzing the server portion to find each remote object in the server portion. The method further includes creating the proxy for each remote object in the server portion and including the proxy in a runtime library. The method further includes analyzing the client portion to determine calls made to remote objects in the server portion and replacing calls for remote objects with calls for a corresponding proxy. The method further includes interposing the runtime library between the client portion and the server portion.

In general, in one aspect, the invention relates to a method for optimizing a distributed application having a server portion and a client portion. The method comprises interposing a runtime between the client portion and the server portion. The runtime comprises at least a proxy associated with a remote object in the server portion. The proxy has a capability to cache state information from the remote object. The method further includes enabling the client portion to interact with the proxy, fetching data from the remote object into the proxy, and synchronizing data in the proxy with data in the remote object.

In general, in one aspect, the invention relates to a computer-readable medium having recorded thereon instructions executable by a processor. The instructions are for generating a proxy for a remote object in a server and making the proxy available to a client, fetching data from the remote object into the proxy, and returning data in the proxy to the remote object.

In general, in one aspect, the invention relates to a computer-readable medium having recorded thereon instructions executable by a processor. The instructions are for analyzing a server portion of a distributed application to find each remote object in the server portion, generating a proxy for each remote object in the server portion, and including the proxy for each remote object in the server portion in a runtime library.

In general, in one aspect, the invention relates to an optimizer for a distributed application which comprises means for creating a local proxy for a remote object in the distributed application, means for fetching data from the remote object into the local proxy, and means for synchronizing data in the local proxy with data in the remote object.

Other aspects of the invention will be apparent from the following description and the appended claims.

### BRIEF DESCRIPTION OF DRAWINGS

FIG. 1 is a block diagram of a distributed application.

FIG. 2 shows a runtime library containing proxy classes interposed between the client and server portions of the distributed application shown in FIG. 1.

### DETAILED DESCRIPTION

Embodiments of the invention provide a method for optimizing a distributed application by injecting proxies into the application. Proxies are full or partial local copies on a client, which can delegate method calls to a server, if necessary. In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

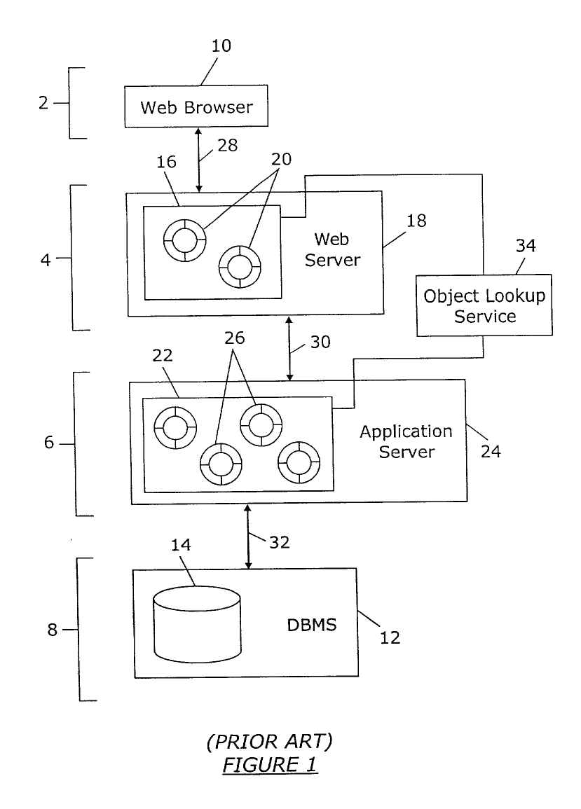

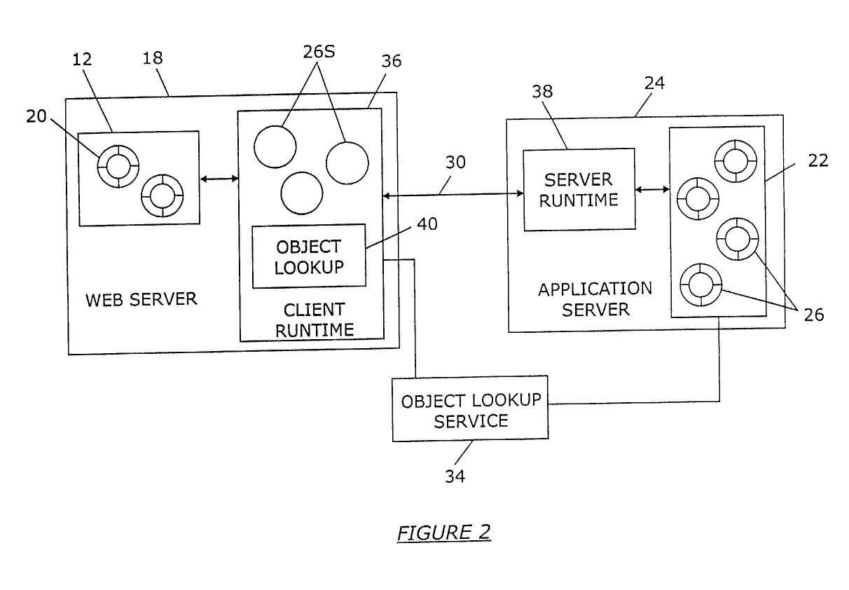

In accordance with an embodiment of the present invention, a method for transparently injecting proxies into an existing distributed application, such as that illustrated in FIG. 1, involves interposing a runtime library (or runtime) between the client program and the server program. A “runtime library” is a set of routines that are bound to a program while the program is executing. FIG. 2 shows a client runtime library 36 interposed between the client program 16 and the server program 22. At runtime, the client runtime library 36 transparently injects proxies 26S into the system and enables the proxies 26S to communicate with the remote objects 26 in the server program 22.

In accordance with one embodiment of the present invention, a server runtime library 38 is also interposed between the client runtime library 36 and the server program 22. At runtime, the server runtime library 38 synchronizes changed attributes of the proxies 26S with the remote objects 26. The server runtime library 38 also provides other functions, such as invoking business methods on the remote objects 26 on behalf of the proxies 26S and collecting and sending changes made to the remote objects 26 to the proxies 26S along with the result of the business method call.

In order to transparently inject proxies 26S into the system, the client program 16 and the server program 22 are independently examined. The server program 22 is initially analyzed to determine the objects whose methods can be remotely invoked (remote objects). This process may involve parsing a descriptor file that contains a list of the classes in the server program 22 and/or examining machine code or source code (if available) for the server program 22. For example, EJB™ applications are deployed with a descriptor file that contains a list of the classes in the application. For each remote object in the server program 22, a proxy (class) is created. The proxy implements the interface of the remote object and has the capability (variables) to cache the remote object's data. The proxies (classes) are included in the client runtime library 36. At runtime, the client runtime library 36 creates an instance of a selected proxy class based on requests from the client program 16.

The client program 16 is next examined to determine where calls are made to the remote objects 26 in the server program 22. For a compiled application, this process would involve parsing the machine code (bytecode) or source code for the client program 16 in order to determine where calls are made to the remote objects 26. All calls to the remote objects 26 will then be replaced with calls to the corresponding proxies 26S.

As previously mentioned, the client program 16 locates the remote objects 26 through an object lookup service 34. In order to prevent direct interaction between the client program 16 and the remote objects 26, the calls to the object lookup service 34 are replaced with calls to an object lookup service 40 included in the client runtime library 36. The object lookup service 40 locates proxies 26S in the client runtime library 36. Thus, when the client program 16 thinks that it is requesting for a remote object 26, it is actually requesting for a proxy 26S. The client runtime library 36 substitutes the proxy 26S for the remote object 26. Before the client runtime library 36 returns the proxy 26S to the client program 16, the client runtime library 36 obtains a reference to the remote object 26 from the object lookup service 34 and stores the reference in the proxy 26S. This stored reference associates the proxy 26S with the appropriate remote object 26.

In addition to the changes to the client program 16 described above, instructions for managing the lifecycle of each remote object 26 originally referenced in the client program 16 are replaced with instructions for managing the lifecycles of the substituted proxies 26S. For example, if the client program 16 includes an instruction for releasing a remote object when the remote object is no longer needed. In accordance with one embodiment of the invention, this instruction would be replaced with an instruction for releasing the proxy substituted for the remote object. This process would again involve examining the machine code or source code for the client program 16 and replacing instructions for releasing remote objects with instructions for releasing proxies.

In operation, the web browser (10 in FIG. 1) or other application client sends a request to the web server 18 for a resource on the web server 18. The web server 18 delegates processing of the request to the client program 16. This processing may include invoking methods on one or more remote objects 26 in the server program 22. Because the client program 16 has been modified as described above, the client program 16 actually makes calls to the client runtime library 36 to request for proxies 26S. When the client runtime library 36 receives a request for a proxy 26S, the client runtime library 36 creates the proxy 26S (if not already created) and returns the proxy 26S to the client program 16. The proxy 26S returned to the client program 16 contains a reference to the actual remote object 26 in the server program 22.

When the proxy 26S is created, it does not contain the remote object's data. The proxy 26S communicates with the server runtime library 38, which retrieves the data from the remote object 26 and sends the data back to the proxy 26S. The data is cached in the proxy 26S and accessed locally by the client program 16. Typically, the client program 16 accesses the data by invoking get methods on the proxy 26S. The client program 16 can also change the data held within the proxy 26S, usually by invoking set methods on the proxy 26S. This changed data is sent back to the server runtime library 38, which updates the remote object 26 with the data. The server runtime library 38 uses the reference stored in the proxy 26S to identity the remote object to updated with data from the proxy 26S.

When the client program 16 invokes a business method (that is, a method that is not a get or set method) on the proxy 26S, the proxy 26S forwards the call to the server runtime library 38. The server runtime library 38 is responsible for invoking the business method call on the proxy 26S and returning the results to the proxy 26S. The proxy 26S then returns the results to the client program 16.

A transport mechanism is needed to pack data, e.g., objects, for transport between the client runtime library 36 and the server runtime library 38. Typically, the process of packing data for transport includes writing the data in a form that is suitable for transport using a network protocol. For example, the data may be written as a byte stream or in other format suitable for transport over a network link. The transport mechanism would also include means for unpacking the data so that the target process can access the data. Remote procedure call (RPC) solutions such as RMI and CORBA (“Common Object Request Broker Architecture”) provide mechanisms for packing (marshaling) data for transport and unpacking (unmarshaling) the data for use by the target process. The transport mechanism (routines) could be included in or provided separately between the client runtime library 36 and the server runtime library 38.

The invention provides advantages in that proxies can be injected into an existing (compiled or ready-to-run) distributed application transparently for the purpose of improving the performance of the application. The proxies can cache state from the remote objects so that data from the remote objects can be accessed locally by the client program. This has the effect of reducing the number of roundtrips between the client and the server.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for transparently injecting a proxy into a distributed application having a server portion and a client portion, comprising:
creating the proxy that implements an interface of a remote object in the server portion and has a capability to cache data from the remote object;
modifying the client portion to substitute a call for the remote object with a call for the proxy; and
interposing a client runtime that includes the proxy between the client portion and the server portion.

2. The method of claim 1, further comprising:
interposing a server runtime between the client runtime and the server portion that enables interaction between the client runtime and the server portion.

3. The method of claim 2, further comprising:
sending a message to the server runtime to fetch data from the remote object.

4. The method of claim 3, further comprising:
receiving data fetched by the server runtime and caching data in the proxy.

5. The method of claim 4, further comprising:
sending a message to the server runtime to synchronize data cached in the proxy with data in the remote object.

6. The method of claim 2, further comprising:
sending a message to the server runtime to invoke a method of the remote object on behalf of the proxy.

7. The method of claim 6, further comprising:
receiving a result of invoking the method of the remote object from the server runtime and passing the result to the proxy.

8. A method for transparently injecting a proxy into a distributed application having a server portion and a client portion, comprising:
creating the proxy for a plurality of remote objects in the server portion, each proxy implementing an interface of a corresponding remote object and having a capability to cache data from the corresponding remote object;
modifying the client portion to substitute a call for a remote object with a call for a corresponding proxy; and
interposing a runtime that includes the proxy between the client portion and the server portion.

9. The method of claim 8, wherein creating the proxy for the plurality of remote objects in the server portion comprises analyzing the server portion to determine the remote objects in the server portion.

10. The method of claim 9, wherein analyzing the server portion comprises parsing machine code for the server portion.

11. The method of claim 9, wherein analyzing the server portion comprises parsing a descriptor containing a list of classes in the server portion.

12. The method of claim 9, wherein analyzing the server portion comprises parsing source code for the server portion.

13. The method of claim 8, wherein modifying the client portion comprises modifying machine code for the client portion.

14. The method of claim 8, wherein modifying the client portion comprises modifying source code for the client portion.

15. The method of claim 8, further comprising:
modifying the client portion to substitute a call to a first lookup service that locates the remote object with a call to a second lookup service that locates the corresponding proxy.

16. The method of claim 15, wherein the lookup service that locates the corresponding proxy is included in the runtime.

17. The method of claim 8, further comprising:
modifying the client portion to substitute a call to manage a lifecycle of the remote object with a call to manage a lifecycle of the corresponding proxy.

18. The method of claim 8, further comprising:
fetching data from the remote object into the proxy associated with the remote object.

19. The method of claim 18, further comprising:
synchronizing data in the proxy with data in the remote object associated with the proxy.

20. The method of claim 8, further comprising:
invoking a method of the remote object on behalf of the proxy associated with the remote object.

21. The method of claim 20, further comprising:
receiving a result of invoking the method of the remote object and passing the result to the proxy.

22. The method of claim 8, wherein the runtime includes a client runtime that interacts with the client portion and a server runtime that interacts with the server portion.

23. The method of claim 22, wherein the client runtime and server runtime communicate in order to enable interaction between the client portion and the server portion.

24. A method for transparently injecting a proxy into a distributed application having a server portion and a client portion, comprising:
analyzing the server portion to find each remote object in the server portion;
creating the proxy for each remote object in the server portion and including the proxy in a runtime library;
analyzing the client portion to determine calls made to remote objects in the server portion and replacing calls for remote objects with calls for a corresponding proxy; and
interposing the runtime library between the client portion and the server portion.

25. A method for optimizing a distributed application having a server portion and a client portion, comprising:
interposing a runtime between the client portion and the server portion, the runtime comprising at least a proxy associated with a remote object in the server portion, the proxy having a capability to cache state information from the remote object;
enabling the client portion to interact with the proxy;
fetching data from the remote object into the proxy; and
synchronizing data in the proxy with data in the remote object.

26. A computer-readable medium having recorded thereon instructions executable by a processor, the instructions for:
generating a proxy for a remote object in a server and making the proxy available to a client;
fetching data from the remote object into the proxy; and
returning data in the proxy to the remote object.

27. The computer-readable medium of claim 26, wherein returning data in the proxy to the remote object comprises returning data modified by the client to the remote object.

28. The computer-readable medium of claim 26, further comprising:
instructions for updating data in the remote object with data in the proxy.

29. The computer-readable medium of claim 26, further comprising:
instructions for invoking a method of the remote object on behalf of the proxy.

30. The computer-readable medium of claim 29, further comprising:
instructions for returning a result of invoking the method of the remote object to the proxy.

31. A computer-readable medium having recorded thereon instructions executable by a processor, the instructions for:
analyzing a server portion of a distributed application to find each remote object in the server portion;
generating a proxy for each remote object in the server portion; and
including the proxy for each remote object in the server portion in a runtime library.

32. The computer-readable medium of claim 31, further comprising:
instructions for modifying a client portion of the distributed application such that a call for a remote object is replaced with a call for a corresponding proxy.

33. An optimizer for a distributed application, comprising:
means for creating a local proxy for a remote object in the distributed application;
means for fetching data from the remote object into the local proxy; and
means for synchronizing data in the local proxy with data in the remote object.

34. The optimizer of claim 33, further comprising:
means for invoking a method of the remote object on behalf of the local proxy.

35. The optimizer of claim 34, further comprising:
means for receiving a result of invoking the method of the remote object and passing the result to the local proxy.

36. The optimizer of claim 33, further comprising:
means for packing data for transport between the local proxy and the remote object.
